(19) United States
(12) Patent Application Publication
(10) Pub. No.: US 2018/0319030 A1
(43) Pub. Date: Nov. 8, 2018

(54) CUTTER

(71) Applicant: SIANG SYUAN FU ENTERPRISE CO., LTD., Changhua County (TW)

(72) Inventor: HUNG-CHIH HUNG, Changhua County (TW)

(21) Appl. No.: 15/586,915

(22) Filed: May 4, 2017

(51) Int. Cl. B26D 3/16

(52) U.S. Cl. CPC B26D 3/169

(57) ABSTRACT

The cutter includes a main body, having a first hole; a blade, connected with the main body and being movable relative to the first hole, the blade having a cutting edge which partially and nondiametrically passes through the first hole when the blade moves relative to the first hole.

### BACKGROUND OF THE INVENTION

### Field of the Invention

The present invention relates to a cutter.

### Description of the Prior Art

In general, people use a knife such as an utility knife, a scissor, etc. for cutting tubes to have an appropriate sized opening. For example, a tubular sealant nozzle of a silicone sealant needs to cut before using. However, the nozzle of the silicone sealant has a greater external diameter and a thickness wall, so it is hard to cut by the utility knife.

Therefore, a conventional cutter is shown in U.S. Pat. No. 8,601,697. A conventional cutter includes a main body, a hole opens towards one side of the main body, and a blade which is connected with the main body and elongated towards to the hole, the hole provides the tubular member to insert therein. Then force the tubular member against the blade and rotate relative to the hole for cutting.

However, the blade of the conventional cutter is secured to the main body, the tubular member can only be pressed towards the blade by external force such as a hand. Besides, if the wall of the tubular member is too thicker, it is hard to cut.

### SUMMARY OF THE INVENTION

The main object of the present invention is to provide a cutter, which provides an effort-saving operation.

To achieve the above and other objects, a cutter of the present invention is provided, including: a main body, having a first hole; a blade, connected with the main body and being movable relative to the first hole; the blade, having a cutting edge which partially and nondiametrically passes through the first hole when the blade moves relative to the first hole.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is a breakdown drawing of the present invention;

FIG. 3 is a break down drawing of a blade of the present invention;

FIGS. 4 to 7 are illustrations of the present invention in use.

### DETAILED DESCRIPTION OF THE PREFERRED EMBODIMENTS

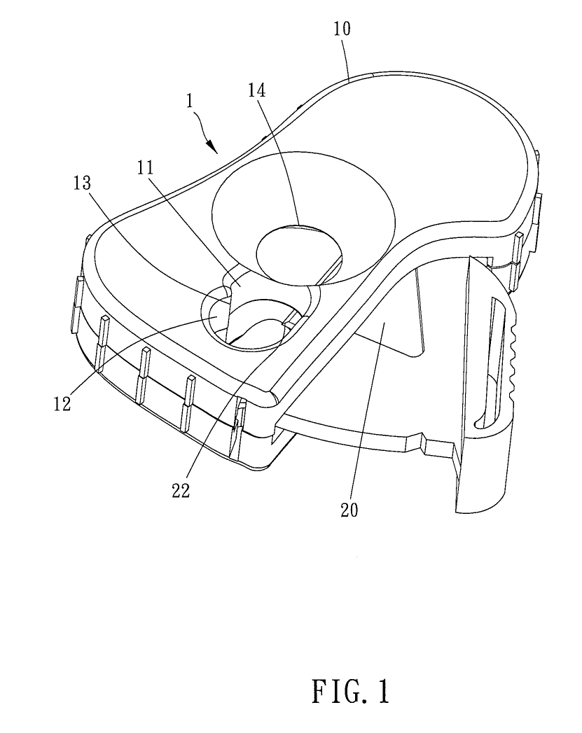

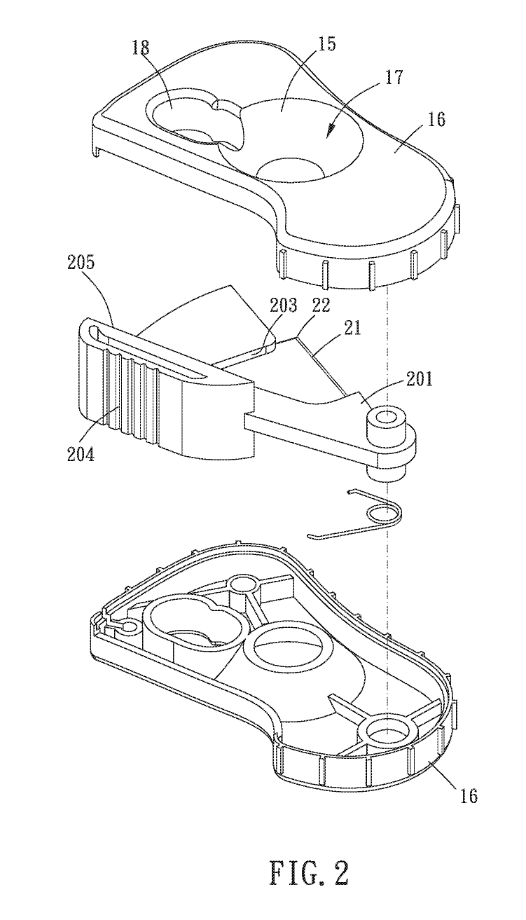

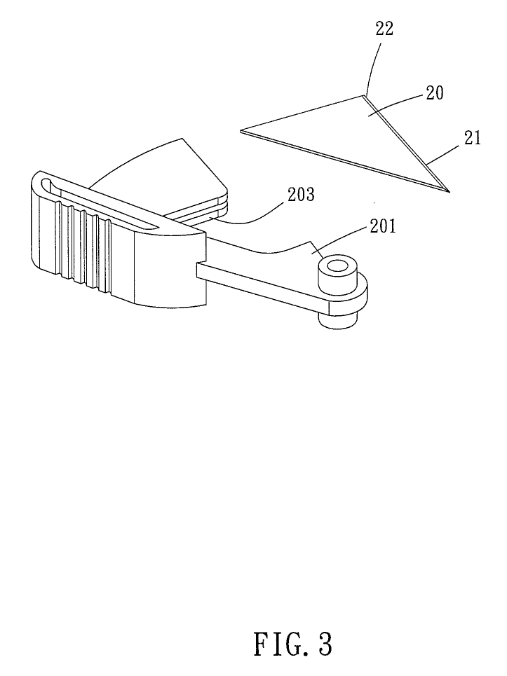

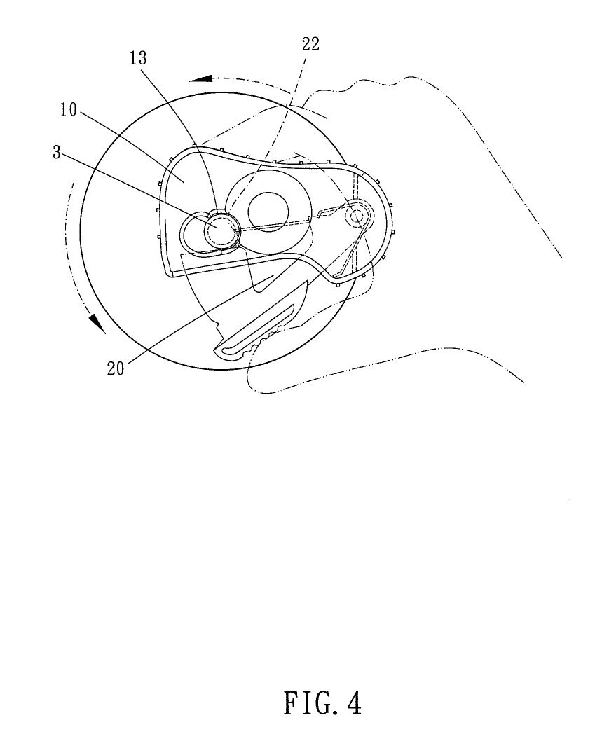

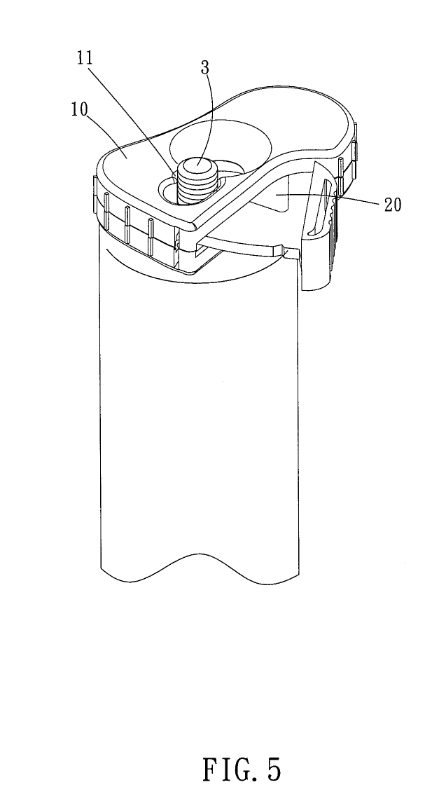

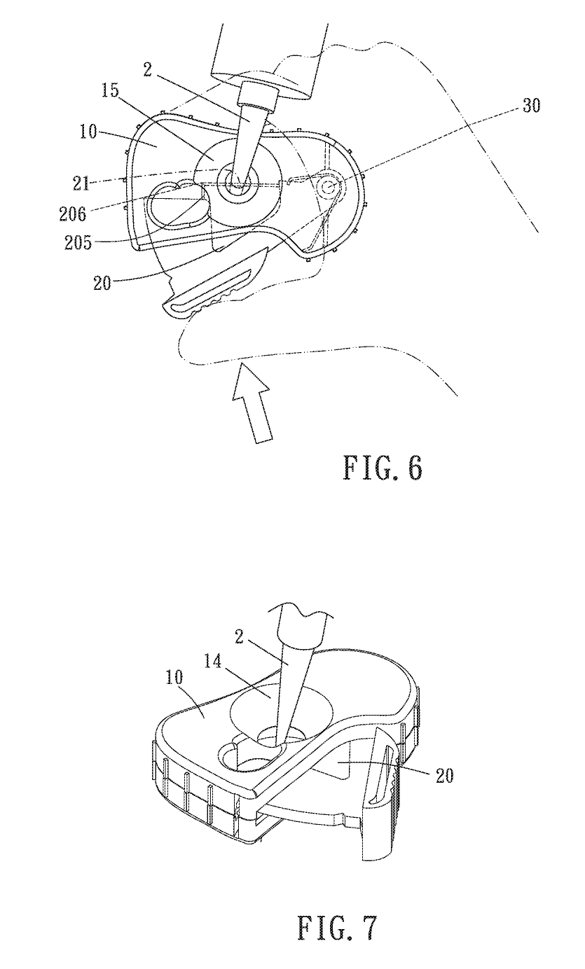

Please refer to FIG. 1 to FIG. 7 for a preferred embodiment of the present invention, the cutter 1 includes a main body 10 and a blade 20.

The main body 10 has a first hole 11; the blade 20 is connected with the main body 10 and being movable relative to the first hole 11, the blade 20 has a cutting edge 21 which partially and nondiametrically passes through the first hole 11 when the cutting edge 21 moves relative to the first hole 11. Specificity, a width of the cutting edge 21 passes through the first hole 11 is less than a diameter of the first hole 11. Thus, it is an effort-saving cutter for cutting the tubular member 3 such as a nozzle, a pipe, etc., and cutting a various thicknesses of the tubular members 3. Therefore, it can save effort when cuts the tubular member 3 by moving the blade 20.

The cutting edge 21 of the blade 20 includes an corner cutting edge 22, the corner cutting edge 22 nondiametrically passes through the first hole 11 when the blade 20 moves relative to the first hole 11. In this embodiment, the corner cutting edge 22 is a right angle for cutting the tubular member 3 easily; the corner cutting edge 22 can be various angles or shapes such as arc shape for various thicknesses, sizes or hardnesses of the tubular member. The blade 20 is pivoted to the main body 10 and rotatable about an axis 30, a distance from the axis 30 to an endmost point 206 of the cutting edge 22 away from the axis 30 is less than a distance from the axis 30 to a center point of the first hole 11, and the endmost point 206 is movable into or out of the first hole 11. A scanning area 205 of the blade 20 overlapping with the first hole 11 during pass of the endmost point 206 through the first hole 11 is smaller than a half of an area of the first hole 11.

The main body 10 further includes a second hole 12 which is communicated with the first hole 11, the second hole 12 can be closed or opened towards the side of the main body 10. Preferably, the diameter of the second hole 12 is greater than the diameter of the first hole 11, so that the tubular member 3 is capable of being inserted into the second hole 12 and moving towards the first hole 11, or inserted into the first hole 11 directly. The second hole 12 provides the tubular member 3 which outer diameter is equally or smaller than the diameter of the second hole 12 to insert therein. Preferably, the first hole 11 has an arc convex 13 which extends therein; the arc convex 13 and the blade 20 urge the opposite side of the tubular member 3 for cutting the tubular member 3 smoothly and without shifting.

The main body 10 further includes a third hole 14, the blade 20 diametrically passes through the third hole 14 when the blade 20 moves relative to the third hole 14. Specificity, a width of the blade 20 passes through the third hole 14 is at least equal to a diameter of the third hole 14, so as to provide a one-time cutting. In other embodiments, the third hole 14 can be plural, the diameter of the plurality of third holes 14 can be the same or with different sizes for inserting the tubular members with various diameters. Besides, the blade 20 passes through all of the third holes 14 at the same time or orderly.

The main body 10 further includes two shell bodies 16 opposite to each other, each of the two shell bodies 16 has a recess 17, the recesses 17 of the two shell bodies 16 extend towards oppositely, and the cutting edge 21 diametrically passes through a gap between the recesses 17 of the two shell bodies 16. The gap is a third hole 14 which communicates with the recesses 17 of the two shell bodies 16, and each recess 17 conically enlarged in a direction away from the third hole 14. Preferably, the third hole 14 is a tapered hole and has an inclined face 15 relative to the blade 20. In this embodiment, the recesses 17 of the two shell bodies 16 have the inclined face 15 respectively, so as the tubular member 3 can be leaning against to the inclined face 15 to be cut the diagonal incision. Wherein, the inclined face 15 surrounds the third hole 14 continuously. Thereby, the tubular member 3 can be cut into a various angular incision by inserting into the third hole 14 with different angles. In this embodiment, the third hole 14 and the first hole 11 are separated or communicated with each other, so as to move the tubular member 3 laterally optionally from one of the first hole 11 and the third hole 14 to the other.

Each of the two shell bodies 16 has a through hole 18, the through holes 18 of the two shell bodies 16 are communicated with each other, and formed the first and second holes 11, 12.

The first, second, and third holes 11, 12, 14 penetrate through the main body 10 relatively, each of the tubular members 2, 3 can be inserted into one of the first, second, and third holes 11, 12 and 14, respectively, with different depths optionally for cutting a various size of diameter of the incision.

The blade 20 is connected to a base 201 which is pivotally connected with the main body 10, the blade 20 is a trapezoid-shaped sheet member, the base 201 has a notch 203, and the blade 20 is disposed within the notch 203. The base 201 is fan-shaped body; the notch 203 opens on a longitudinal side of the base 201. The base 201 gradual enlarges from the side is pivoted to the main body 10 to the opposite side, to save an effort when cutting the tubular member 3. The side of the base 201 opposites to the notch 203 of the base 201 has a press portion 204; the press portion 204 has a wall 205 is corresponded to the two shell bodies 16, so the blade 20 can be stopped by the side of the two shell bodies 16 for restricting the moving range thereof.

In use, the tubular members 2, 3 optionally insert into one of the first, second, third holes 11, 12, and 14, respectively. When the tubular member 3 is inserted into the first hole 11, the cutting edge 21 of the blade 20 can be thrust into the tubular member 3, then rotate the tubular member 3 relative to the first hole 11 for cutting it. When the tubular member 2 is inserted into the third hole 14, the cutting edge 21 can totally cut off the tubular member 2 and form the incision thereof.

1. A cutter, including:
a main body having a first hole;
a blade connected with the main body and being movable relative to the first hole, the blade having a cutting edge;
wherein the blade is pivoted to the main body and rotatable about an axis, a distance from the axis to an endmost point of the cutting edge away from the axis is less than a distance from the axis to a center point of the first hole, and the endmost point is movable into or out of the first hole;
wherein a scanning area of the blade overlapping with the first hole during pass of the endmost point through the first hole is smaller than a half of an area of the first hole; and
wherein the main body further includes a second hole which is communicated with the first hole, the diameter of the second hole is greater than the diameter of the first hole, and the first and second holes form an enclosed hole.

2. The cutter of claim 1, wherein the cutting edge of the blade includes a corner cutting edge, the corner cutting edge passes through the first hole when the blade moves relative to the first hole.

3. (canceled)

4. The cutter of claim 1, wherein the main body further includes a third hole, and the cutting edge passes through the third hole when the blade moves relative to the third hole.

5. The cutter of claim 4, wherein the third hole is a tapered hole and has an inclined face relative to the blade.

6. The cutter of claim 1, wherein the main body further includes two shell bodies opposite to each other, each of the two shell bodies has a recess, the recesses of the two shell bodies extend oppositely, and the cutting edge passes through a gap between the recesses of the two shell bodies.

7. The cutter of claim 6, wherein the gap is communicated with the recesses of the two shell bodies, and the recesses of the two shell bodies are conically enlarged in opposite directions and away from the gap.

8. The cutter of claim 1, wherein the blade is connected to a base which is pivotally connected with the main body, the base has a notch, and the blade is disposed within the notch.

9. The cutter of claim 8, wherein the notch opens on a longitudinal side of the base.

10. The cutter of claim 5, wherein the cutting edge of the blade includes a corner cutting edge, the corner cutting edge passes through the first hole when the blade moves relative to the first hole; the main body further includes two shell bodies opposite to each other, each of the two shell bodies has a recess, the recesses of the two shell bodies extend oppositely, and the cutting edge passes through a gap between the recesses of the two shell bodies; the first hole has an arc convex which extends therein; each of the two shell bodies has a through hole, the through holes of the two shell bodies are communicated with each other, and the through holes of the two shell bodies form the first and second holes; the gap is communicated with the recesses of the two shell bodies, and the recesses of the two shell bodies are conically enlarged in opposite directions and away from the gap; the first, second, and third holes penetrate through the main body respectively; the third hole and the first hole are disposed separately on the main body; the blade is connected to a base which is pivotally connected with the main body, the base has a notch, and the blade is disposed within the notch; the notch opens on a longitudinal side of the base; the base gradually enlarges from a side which is pivoted to the main body to an opposite side; and a side of the base opposites to the notch of the base has a press portion, the press portion has a wall which is corresponded to the two shell bodies.
